(19) United States
(12) Patent Application Publication
(10) Pub. No.: US 2020/0156150 A1
(43) Pub. Date: May 21, 2020

(54) OBJECT SHAPING SYSTEM

(71) Applicant: CANON KABUSHIKI KAISHA, Tokyo (JP)

(72) Inventor: Atsushi Ito, Tokyo (JP)

(21) Appl. No.: 16/680,837

(22) Filed: Nov. 12, 2019

(30) Foreign Application Priority Data
Nov. 19, 2018 (JP) 2018-216550

(51) Int. Cl. B22F 3/00; B29C 64/165; B29C 64/295; B29C 64/393; B29C 64/371; B29C 64/255; B29C 64/236; B33Y 30/00; B33Y 50/02

(52) U.S. Cl. CPC B22F 3/008; B29C 64/165; B29C 64/295; B29C 64/393; B33Y 50/02; B29C 64/255; B29C 64/236; B33Y 30/00; B29C 64/371

(57) ABSTRACT

An object shaping system includes an object shaping portion including a powder layer forming unit which forms a powder layer in a vessel using a first powder and a liquid supplying unit which supplies, to a local region of the powder layer, a liquid for solidifying the first powder, the object shaping portion forming a layered object in the vessel, a first heating portion to heat the vessel, a conveyance mechanism conveying the vessel, and a control unit which controls the object shaping portion, the first heating portion, and the conveyance mechanism. Each of the object shaping portion, the first heating portion, and the conveyance mechanism is an independent unit. When the object shaping operation is completed, the control unit disconnects, from the object shaping portion, the vessel and causes the conveyance mechanism to convey the vessel from the object shaping portion to the heating portion.

### BACKGROUND OF THE INVENTION

### Field of the Invention

The present invention relates to an object shaping system.

### Description of the Related Art

As a method of shaping a solid object, an additive manufacturing method in which a building material is deposited in layers based on slice data of a solid object model as an object to be shaped has drawn attention. Conventionally, object shaping using a resin material has been a main stream but, in recent years, devices which perform object shaping using a building material other than resin, such as metal or ceramic, have increased.

Japanese Patent Application Publication No. 2015-38237 discloses a method which repeats a step of forming a thin layer of a power material on a substrate and then locally performing high-temperature heating using a laser to sinter the powder material, and thus obtains a shaped object. In the method disclosed in Japanese Patent Application Publication No. 2015-38237, when a structure such as an overhang structure or a structure having a movable portion is to be formed over a region (hereinafter referred to as the “non-shaping region”) where the powder material has not been sintered, the powder material present in an upper portion of the non-shaping region should be sintered. At that time, local thermal shrinkage may cause warping. Consequently, depending on a shape of the structure, it may be required to shape an object by adding a support body (referred to also as a support structure) which inhibits warping. Since the support body is an intrinsically unneeded structure, depending on the shape of the solid object model, it may be required to remove the support body. Accordingly, it is difficult to shape a solid object model having a shape or a structure from which it is difficult to remove the support body. Particularly when the support body is to be removed from a metal shaped object, it is required to use a metal working machine, and therefore a minute structure from which it is physically difficult to remove the support body using the metal working machine cannot be shaped. In addition, since ceramics are likely to be damaged under a load, it is difficult to selectively remove the support body from a ceramic shaped object.

Meanwhile, there has been known a method in which, after a shape of a shaped object is formed using a mixed material containing metal or ceramic particles and a resin binder, a resin is removed (defatting), and the particles are sintered to each other to allow a metal or ceramic shaped object to be obtained. Japanese Patent Application Publication No. 2015-205485 discloses a method in which, after a step of coating a building layer containing metal particles with a liquid binder and solidifying the building layer is repeated, an unsolidified region is removed to allow a composite shaped object containing the resin and the metal particles to be produced. From the composite shaped object obtained, the resin is removed, and a sintering process for sintering the metal particles to each other is performed in a sintering furnace to allow the metal shaped object to be obtained.

In the method disclosed in Japanese Patent Application Publication No. 2015-205485, when a shape having an overhang structure, a structure having a movable portion, or the like is to be formed, object shaping can be performed using powder (unsolidified powder) uncoated with the binder as a replacement for the support body.

However, in a method as described in Japanese Patent Application Publication No. 2015-205485, a sintering furnace in which a sintering process is to be performed is required in addition to an object shaping device in which a step of depositing building layers is to be performed. Accordingly, it is concerned that a problem of extra time and labor required to convey a composite shaped object from the object shaping device to the sintering furnace may occur.

In addition, since a period required for each of the steps may range from several hours to several tens of hours, in order to continuously perform a process without degrading productivity, it is required to prepare workers including night-shift workers, which requires labor and time of the workers.

The present invention has been achieved in view of circumstances as described above, and an object of the present invention is to reduce labor and working hours required of workers and improve productivity.

### SUMMARY OF THE INVENTION

It is provided an object shaping system comprising:

an object shaping portion including a powder layer forming unit which forms a powder layer in a vessel using a first powder and a liquid supplying unit which supplies, to a local region of the powder layer, a liquid for solidifying the first powder based on three-dimensional shape data of a solid model, the object shaping portion repeatedly performing a sequential object shaping operation including an operation of forming the powder layer which is performed by the powder layer forming unit and an operation of supplying the liquid which is performed by the liquid supplying unit to form a layered object in the vessel;

a first heating portion which performs a heating operation of heating the vessel in which the layered object is formed by the object shaping portion;

a conveyance mechanism capable of conveying the vessel; and

a control unit which controls the object shaping portion, the first heating portion, and the conveyance mechanism, wherein

each of the object shaping portion, the first heating portion, and the conveyance mechanism is an independent unit, and,

when the object shaping operation performed by the object shaping portion is completed, the control unit disconnects, from the object shaping portion, the vessel in which the layered object is formed and causes the conveyance mechanism to convey the vessel from the object shaping portion to the heating portion.

Further features of the present invention will become apparent from the following description of exemplary embodiments (with reference to the attached drawings).

### BRIEF DESCRIPTION OF THE DRAWINGS

FIGS. 1A and 1B are views illustrating an object shaping system of a first embodiment;

FIG. 2 is a view illustrating an object shaping system of a second embodiment;

FIG. 3 is a view illustrating an object shaping system of a third embodiment; and

FIG. 4 is a view illustrating an object shaping system of a fourth embodiment.

### DESCRIPTION OF THE EMBODIMENTS

Referring to the drawings, the following will describe preferred embodiments of the present invention. However, the dimensions, materials, shapes of components described below, relative positioning thereof, and the like are to be appropriately modified depending on a configuration of a device to which the present invention is to be applied and various conditions, and are therefore not intended to limit the scope of the present invention to the following description. In particular, to a configuration and a step which are not illustrated or described, a widely known or well-known technique in the technical field is applicable. Also, a repeated description may be omitted.

The present invention relates to a technique for shaping a solid shaped object using a building material in the form of particles. A method of the present invention can appropriately be used for an object shaping process in an object shaping system referred to as an additive manufacturing (AM) system, a three-dimensional printer, a rapid prototyping system, or the like.

An object shaping system according to each of the embodiments of the present invention includes a device which repeatedly performs a sequential object shaping operation including a powder layer forming step and a liquid supplying step to shape a solid object. The powder layer forming step mentioned herein is a step of leveling powder to form a powder layer on a shaping table (stage) lowered in height by a layer pitch. The liquid supplying step mentioned herein is a step of supplying a liquid for binding the powder to a local region of the formed powder layer based on slice data of an object to be shaped.

Alternatively, the object shaping system according to the embodiment of the present invention includes a device which repeatedly performs a sequential object shaping operation including a powder layer forming step, a liquid supplying step, and a solidifying step to form a solid object. In this device, in the liquid supplying step, to a local region of the powder layer formed in the powder layer forming step described above, a liquid binder is added based on slice data of an object to be shaped. Then, in the solidifying step, the binder added in the liquid supplying step is cured to solidify the powder in the local region.

In the present specification, a solid model (i.e., a solid object represented by three-dimensional shape data given to the object shaping system) to be shaped using the object shaping system is referred to as an “object to be shaped”. Also, an aggregate of a plurality of particles used as the building material is referred to as “powder”, and the powder leveled to have a predetermined thickness is referred to as a “powder layer”. The powder corresponds to a first powder. Also, a plurality of powder layers formed on the shaping table by alternately repeating the powder layer forming step and the liquid supplying step is referred to as a “layered object”. A region (local region of the powder layer) to which the liquid is to be added in the liquid supplying step is referred to as a “shaping region”, while a region (outside the local region) of the powder layer other than the shaping region is referred to as a “non-shaping region”. The shaping region refers to a region corresponding to a cross section of the object to be shaped, i.e., a portion of the powder layer in which the powder is to be solidified and from which the solidified powder is to be retrieved as the shaped object. Through removal of the non-shaping region from the layered object, the “shaped object” corresponding to the object to be shaped is obtained. At this time, a solidifying step (which may be referred to also as a heating step) of solidifying the region (shaping region) to which the liquid is added by means of drying, heating, or the like may be performed appropriately. By removing the unsolidified region (non-shaping region) of the layered object, it is possible to obtain the shaped object. The shaped object also includes a shaped object having an increased strength which is obtained by further performing a heating process on the shaped object resulting from the solidifying step so as to sinter the shaped object. It is assumed herein that the shaped object also includes a shaping region obtained by performing the powder layer forming step and the liquid supplying step to deposit one layer. The shaped object need not necessarily have a high strength.

As particles forming the powder as the building material, resin particles, metal particles, ceramic particles, or the like can be used appropriately. However, the particles forming the powder may also be made of a metal to which a non-metal element such as carbon is added, such as a metal alloy or carbon steel. Alternatively, the particles forming the powder may also be composite particles made of a plurality of metals, composite particles made of a plurality of ceramics, or the like.

Since a fluidity of the powder varies depending on a humidity, the powder before object shaping is preferably reserved in a dry environment and, during object shaping also, the powder is preferably kept in a state as dry as possible. As the liquid to be used in the liquid supplying step, a dispersion liquid in which powder including nano-sized particles is dispersed, a binding liquid for binding the powder, or the like can appropriately be used. The nano-sized particles mentioned herein refer to particles having an average particle diameter sufficiently smaller than an average particle diameter of the powder as the building material. As the nano-sized particles, resin particles, metal particles, ceramic particles, or the like can be used. Powder including the nano-sized particles corresponds to a second powder contained in the liquid.

A volume-based average particle diameter of the powder (first powder) forming the powder layer is preferably selected in a range of at least 1 μm and not more than 500 μm and, more preferably selected in a range of at least 1 μm and not more than 500 μm, and not more than 100 μm. On the other hand, a volume-based average particle diameter of the powder (second powder) including the nano-sized particles is preferably selected in a range of at least 1 nm and not more than 500 nm and, more preferably selected in a range of at least 1 nm and not more than 200 nm. It is assumed that, before object shaping is started, from three-dimensional shape data of the object to be shaped, slice data for forming each of layers was generated by the object shaping device or an external device (such as, e.g., a PC (personal computer)). As the three-dimensional shape data, data produced using a three-dimensional CAD, a three-dimensional modeler, a three-dimensional scanner, or the like can be used. For example, a STL file or the like can be used appropriately. The slice data is data obtained by slicing a three-dimensional shape of the object to be shaped at predetermined intervals (thicknesses), which is data including information such as shapes of cross sections, thicknesses of layers, and a layout of materials. Since the thicknesses of the layers affect object shaping accuracy, the thicknesses of the layers may be determined appropriately based on required object shaping accuracy and on particle diameters of the particles to be used for object shaping.

### EMBODIMENTS

The present inventors have invented a method in which, to increase flexibility of a shape of an object to be shaped, powder materials having different particle diameters are used as the building material, and the material having a relatively small particle diameter is used as a binding material. The method utilizes a phenomenon in which the powder materials having different particle diameters are sintered or melt at different temperatures and includes, e.g., steps illustrated below:

(Step 1) the step of performing a forming operation of forming the powder layer in an object shaping bin using the first powder;

(Step 2) the step of performing a supplying operation of supplying the second powder to the shaping region of the formed powder layer;

(Step 3) the step of repeating Steps 1 and 2 to deposit an arbitrary total number of the powder layers in the object shaping bin (vessel);

(Step 4) the step of performing a heating operation of heating the second powder which is contained in the object shaping bin to a temperature (first temperature) at which the second powder is sintered or melt to solidify the first powder in the shaping region and obtain the shaped object <Primary Heating Process>; and

(Step 5) the step of removing the first powder from the non-shaping region in the object shaping bin.

The method can enhance a strength of the shaped object by additionally including a step illustrated below:

(Step 6) the step of heating the shaped object to a temperature (second temperature) at which the first powder is sintered or melt <Secondary Heating Process>.

In the method, the first temperature in Step 4 is lower than the second temperature in Step 6. The steps illustrated above can be executed using, e.g., a device (3D printer) in charge of Steps 1 to 3, a device (e.g., a sintering furnace) in charge of Steps 4 and 6, a device in charge of Step 5, or through manual procedures. The present inventors have found that such a method can increase the flexibility of the shape of the object to be shaped.

As described above, the present invention can appropriately be applied to the object shaping system using the different sintering temperatures of the powders, but is not limited thereto. For example, the present invention can also be applied appropriately to an object shaping system which produces a shaped object using a method including steps illustrated below:

(Step 11) the step of forming, using the powder, the powder layer in the object shaping bin;

(Step 12) the step of supplying a liquid binder (e.g., resin binder) to the shaping region of the formed powder layer;

(Step 13) the step of performing a solidifying operation of curing the liquid binder to solidify the powder in the shaping region;

(Step 14) the step of repeating Steps 11 to 13 to form the layered object including the shaped object in the object shaping bin;

(Step 15) the step of performing a heating operation of heating the layered object which is contained in the object shaping bin to the temperature (first temperature) at which the binder is cured to solidify the first powder in the shaping region and obtain the shaped object <Primary Heating Process>; and

(Step 16) the step of removing the powder located in the non-shaping region from the layered object in the object shaping bin.

The method can enhance the strength of the shaped object by additionally including a step illustrated below:

(Step 17) the step of heating the shaped object to a temperature at which the powder is sintered or melt.

### First Embodiment

The following will more specifically describe a device configuration for implementing the object shaping system using the different sintering temperatures of the powders described above. Note that, in the first embodiment, a description will be given of a mode in which Steps 1 to 4 described above are performed to allow the shaped object to be obtained.

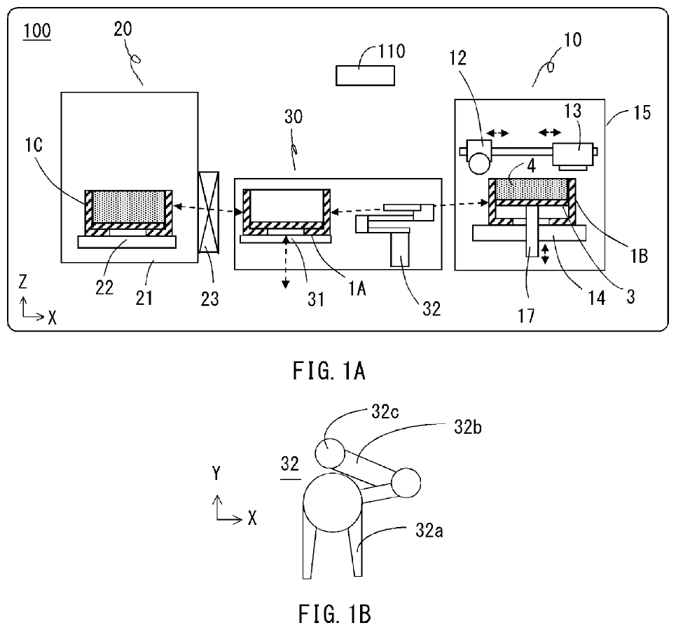

FIG. 1A is a view illustrating components of the first embodiment and illustrates an object shaping system 100 including an object shaping unit (object shaping portion) 10, a heating unit (heating portion) 20, a conveyance unit (conveyance mechanism) 30, and a control unit 110. The object shaping unit 10, the heating unit 20, and the conveyance unit 30 are configured as respective independent units and can be controlled individually or cooperatively by the control unit 110. Each of object shaping bins 1 (1A, 1B, and 1C) is configured to be able to be placed in and disconnected from the object shaping unit 10, the heating unit 20, and the conveyance unit 30. Note that, in FIG. 1A, for convenience of description, a state is illustrated in which the object shaping bins 1A, 1B, and 1C are placed on all the mounting portions on which the object shaping bins can be placed. However, in a real situation, there is no such a state, and nothing is placed on the mounting portion to which the conveyance unit 30 conveys the object shaping bin. In FIG. 1A, dotted lines represent spaces between the mounting portions in which the object shaping bins are movable.

The object shaping unit 10 has a lifting mechanism 14, a powder layer forming unit 12, and a liquid supplying unit 13. The lifting mechanism 14 has an up-down rod (up-down mechanism) 17 which supports the object shaping bins 1 (1A, 1B, and 1C) and lifts up/down a bottom plate 3 of each of the object shaping bins 1. Each of the object shaping bins 1 is a vessel in the form of a box having upper and lower open surfaces. In the object shaping bin 1, the bottom plate 3 is disposed to be vertically movable. The powder layer forming unit 12 is intended to supply the first powder onto the bottom plate 3 in the object shaping bin 1 and level an upper surface of the first powder to form the powder layer. The liquid supplying unit 13 is intended to add a liquid for binding the powder to a local region of the powder layer formed by the powder layer forming unit 12 based on slice data of the object to be shaped.

By repeatedly performing a sequential object shaping operation including formation of the powder layer and the liquid supplying operation based on the three-dimensional shape data, it is possible to obtain, in the object shaping bin 1, the layered object 4 in which each of the powder layers has been subjected to arbitrary three-dimensional patterning. This process may be hereinafter referred to as an object shaping process. It may be possible that respective operations of the powder layer forming unit 12, the liquid supplying unit 13, and the lifting mechanism 14 are controlled by the control unit 110. However, it may also be possible to provide the object shaping unit 10 with an object shaping control unit cooperating with the control unit 110 and control the respective operations of the powder layer forming unit 12, the liquid supplying unit 13, and the lifting mechanism 14 using the object shaping control unit.

The heating unit 20 is provided with a heating mechanism not illustrated and capable of increasing a temperature inside a confining wall 21 covering a main body of the heating unit to a high level of several hundreds of degrees to one thousand and several hundreds of degrees and performing a heating process. The heating unit 20 may also include a replacement device not illustrated and capable of replacing a gas in the heating unit 20 with any gas of argon, nitrogen, or the like. The confining wall 21 is provided with a heat insulating property in terms of safety and energy efficiency. The heating unit 20 also includes a supporting portion 22 which allows the object shaping bin 1 to be placed thereon and supported in the heating unit 20. The heating unit 20 is configured so as to be able to perform a process of heating the entire object shaping bin 1 to a high temperature. The heating performed by the heating unit 20 allows the liquid for binding the powder in the object shaping bin 1 to solidify only a patterned portion. Specifically, by performing the primary heating process in which the object shaping bin 1 is heated to a temperature at which the second powder contained in the liquid is sintered or melt, the second powder is allowed to fix the particles included in the first powder to each other. After the heating process is ended, the shaped object formed in the object shaping bin 1 and having an arbitrary shape can be extracted therefrom.

The object shaping bin 1 can be moved from the object shaping unit 10 to the heating unit 20 by, e.g., a worker by manually conveying the object shaping bin 1. However, the manual conveyance requires labor and time of the worker. For example, when it is assumed that each of sides of the object shaping bin 1 has a length of 200 mm and stainless-steel powder is deposited in layers as the first powder at a filling ratio of 70%, only the stainless-steel powder has a weight over 40 kg. This is a weight level hard to be manually handled by only one worker, and considerable labor and time is required to place the object shaping bin 1 as a heavy load in the device. In addition, the object shaping process and the heating process each described above may require a period of several to several tens of hours and, in order to continuously and constantly perform the processes so as not to degrade productivity, it is required to prepare workers including night-shift workers.

Accordingly, in the object shaping system 100 of the first embodiment, the conveyance unit 30 is provided. The conveyance unit 30 has a mounting table 31 as a mounting portion on which the object shaping bin 1 can be placed and a conveyance means 32 capable of conveying the object shaping bin 1.

The conveyance means 32 is configured to be able to disconnect the object shaping bin 1 from the object shaping unit 10, convey the object shaping bin 1 to the heating unit 20, and place the object shaping bin 1 in the heating unit 20. Preferably, the object shaping unit 10 has a configuration in which, when the object shaping bin 1 is disconnected from the object shaping unit 10, the up-down rod 17 comes off the bottom plate 3 to remain in the object shaping unit 10, but the configuration of the object shaping unit 10 is not limited thereto. In the first embodiment, the conveyance means 32 is capable of conveying the object shaping bin 1 between the mounting table 31 and the object shaping unit 10, and is also capable of conveying the object shaping bin 1 between the mounting table 31 and the heating unit 20. As an example of the conveyance means 32, in FIG. 1A, a hand robot (which may be hereinafter referred to as a hand robot 32) is illustrated. FIG. 1B illustrates a plan view of the hand robot 32. As illustrated in FIG. 1B, the hand robot 32 has a holding portion 32a, a moving portion 32b, and a rotating shaft portion 32c.

As illustrated in FIG. 1B, the holding portion 32a includes two hand portions. By lifting up the object shaping bin 1 in an upward direction (Z-direction) using the two hand portions, it is possible to freely move the object shaping bin 1. The moving portion 32b is intended to rotate and/or move the holding portion 32a in an XY-plane (horizontal plane). The rotating shaft portion 32c rotatably supports the moving portion 32b, while allowing the holding portion 32a and the moving portion 32b to vertically move.

Between the conveyance means 32 and the object shaping bin 1, a vibration damping means for reducing vibration transmitted from the conveyance means 32 to the object shaping bin 1 may be provided appropriately. The vibration damping means can reduce the vibration applied to the layered object 4 in the object shaping bin 1 when the object shaping bin 1 in which the layered object 4 is formed is conveyed by the conveyance unit 30. The vibration damping means may appropriately have, e.g., an attenuation mechanism having a function of a spring member and/or a damper member.

The control unit 110 is a control unit having at least one processor, which is intended to control the entire object shaping system including the object shaping unit 10, the heating unit 20, and the conveyance unit 30. The control unit 110 extracts constants and variables for operating the control unit 110, a program read from a storage unit, and the like into a RAM and executes them to implement each of the processes of the first embodiment.

The control of the conveyance unit 30 by the control unit 110 allows the conveyance unit 30 to automatically move the object shaping bin 1 between the individual process steps of the object shaping system.

For example, the control unit 110 performs movement control as illustrated below.

The worker places the object shaping bin 1 on the mounting table 31 of the conveyance unit 30 to allow the conveyance means 32 to automatically convey the object shaping bin 1 to the object shaping unit 10 and place the object shaping bin 1 at a predetermined position on a table of the lifting mechanism 14 in the object shaping unit 10. At this time, the object shaping bin 1 may appropriately be fixed at the predetermined position by a fixing mechanism. Then, in the object shaping unit 10, the object shaping process is performed. The up-down rod 17 is configured to be moved up/down by an actuator during the object shaping process to allow the bottom plate 3 to be lifted up/down in association therewith.

When the object shaping process is executed and the layered object 4 is formed, the up-down rod 17 moves down to bring the bottom plate 3 to the bottom. When the object shaping bin 1 is fixed using the fixing mechanism, the fixed state of the object shaping bin 1 resulting from the fixing mechanism is cancelled. This brings the object shaping bin 1 into a movable state. At this time, the bottom plate 3 is stabilized by its own weight and a weight of the layered object 4, and the object shaping bin can be moved without entailing a collapse of the powder in the layered object 4.

In this state, the conveyance means 32 automatically conveys the object shaping bin 1 from the object shaping unit 10 to the heating unit 20. Subsequently, in the heating unit 20, the primary heating process is performed on the object shaping bin 1, and then the conveyance means 32 automatically returns the object shaping bin 1 to the mounting table 31.

Note that the confining wall 21 of the heating unit 20 may appropriately be provided with an automatic gate valve 23. When the conveyance means 32 moves the object shaping bin 1 to the heating unit 20, the control unit 110 opens the automatic gate valve 23. Subsequently, the conveyance means 32 places the object shaping bin 1 on the supporting portion 22 in the heating unit 20 and moves from the inside of the heating unit 20 to the outside thereof, and then the control unit 110 closes the automatic gate valve 23. This can inhibit a high-temperature atmosphere in the heating unit 20 from leaking to the outside thereof and affecting the surroundings of the heating unit 20.

As described above, the first embodiment allows the conveyance unit 30 to automatically transport the object shaping bin between the object shaping unit 10 and the heating unit 20. As a result, the worker can obtain the layered object 4 subjected to the primary heating process without effecting step movement between the object shaping unit 10 and the heating unit 20. Therefore, it is possible to reduce the labor and working hours required of the worker and improve productivity.

### Second Embodiment

The following will describe a second embodiment. Note that the following will describe a configuration and a process which are different from those in the first embodiment, and a description of the same configuration and the same process as those in the first embodiment is omitted.

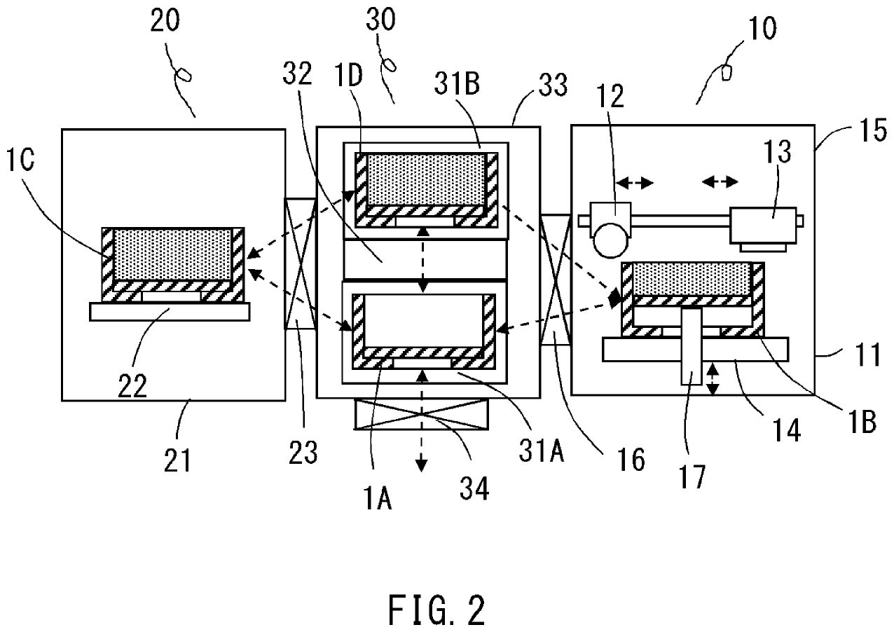

FIG. 2 is a view illustrating the object shaping system 100 of the second embodiment. FIG. 2 illustrates the object shaping system having the following two configurational differences with the object shaping system 100 in FIG. 1A.

The first difference is that the conveyance unit 30 of the second embodiment has a plurality of the mounting tables. FIG. 2 illustrates an example in which two mounting tables 31A and 31B are set.

The second difference is that the conveyance unit 30 of the second embodiment is covered with a housing 33 and, between the housing 33 and a housing 15 of the object shaping unit 10 and between the housing 33 and the confining wall 21 of the heating unit 20, an automatic gate valve 16 and the automatic gate valve 23 are respectively provided.

A description will be given first of the plurality of mounting tables.

As described in the first embodiment, the object shaping process and the heating process may require a period of several to several tens of hours. The required period depends on details of the processes such as a size of the object shaping bin 1 and the number of deposited layers. In other words, the period required by each of the processes is not necessary the same and, in most cases, the object shaping process and the heating process are not simultaneously ended.

For example, consideration will be given of a case where, in FIG. 1A, a heating process to be performed on the object shaping bin 1A and an object shaping process to be performed on the object shaping bin 1B are performed in parallel. Even when the process performed on the object shaping bin 1B is ended earlier, the process is performed on the object shaping bin 1A in the heating unit 20, and therefore the object shaping bin 1B is not allowed to proceed to the next primary heating process. At this time, the object shaping bin 1B can be conveyed to the mounting table 31 of the conveyance unit 30 but, afterward, the object shaping bin 1C to be subjected to the next object shaping process cannot be conveyed to the object shaping unit 10. Thus, a problem is encountered that, while the object shaping unit 10 can inherently operate independently of the heating unit 20, since the object shaping bin 1C cannot be conveyed to the object shaping unit 10, wasted time during which no process can be performed occurs.

In the second embodiment, as a means for solving such a problem, the plurality of mounting tables are provided in the conveyance unit 30. FIG. 2 illustrates the example in which the conveyance unit 30 includes the two mounting tables 31A and 31B.

By thus configuring the conveyance unit 30, in the situation described above, i.e., when the heating process and the object shaping process are respectively performed in parallel on the object shaping bin 1A and the object shaping bin 1B and when the process performed on the object shaping bin 1A is ended earlier, the following measures can be taken. Specifically, it is possible to allow the conveyance means 32 to convey the object shaping bin 1B for which the process in the object shaping unit 10 was ended to the mounting table 31B and allow the conveyance means 32 to convey the unprocessed object shaping bin 1C placed in advance on the mounting table 31A (by, e.g., the worker) to the object shaping unit 10.

This allows the object shaping unit 10 to proceed to execute the next object shaping process on the object shaping bin 1C. Then, when the primary heating process performed on the object shaping bin 1A in the heating unit 20 is completed, the conveyance means 32 conveys the object shaping bin 1A from the heating unit 20 to the mounting table 31A to allow the worker to retrieve the object shaping bin 1A from the mounting table 31A and proceed to perform an operation of extracting the shaped object in the object shaping bin 1A therefrom. At this time, the conveyance means 32 also conveys the object shaping bin 1B on the mounting table 31B to the heating unit 20 to allow the primary heating process for the object shaping bin 1B to be started.

In other words, the plurality of mounting tables serve as conveyance buffers for the object shaping bins 1 to be able to absorb differences between respective processing periods of the individual steps. Accordingly, the device can efficiently operate without having useless standby times in the individual process steps to be able to increase the productivity of the object shaping system.

Preferably, the plurality of mounting tables are provided as described above, but it may also be possible to configure the mounting table such that the plurality of object shaping bins 1 can be placed on one mounting table.

Subsequently, a description will be given of the housings and the automatic gate valves.

There is a case where the object shaping unit 10 handles explosive powder of, e.g., titanium, aluminum, or the like. In this case, the object shaping unit 10 is partially or entirely covered with the housing 15, and a gas supply mechanism, not illustrated, fills the housing 15 with an inert gas of argon, nitrogen, or the like to inhibit occurrence of a powder dust explosion. Since each of the object shaping bins 1 has the powder therein, the object shaping bin 1 is one of parts to be covered with the inert gas in the housing 15. However, the object shaping unit 10 including the powder layer forming unit 12, the lifting mechanism 14, and the liquid supplying unit 13 each as a movable portion tends to have a large size. At this time, when the gas in the housing 15 of the relatively large-sized object shaping unit 10 is replaced with atmospheric air every time one object shaping bin 1 is conveyed, a problem is encountered that each replacement requires time.

In view of this, in the second embodiment, the entire conveyance unit 30 is covered with the housing 33, and the gas supply mechanism, not illustrated, which allows the gas even in the housing 33 of the conveyance unit 30 to be replaced with argon, nitrogen, or the like is provided. The conveyance unit 30 having fewer components than those of the object shaping unit 10 is easily configured to have a small size. The object shaping unit 10 and the conveyance unit 30 are connected via the automatic gate valve 16.

By providing such a configuration, it is possible to allow the conveyance means 32 to convey each of the object shaping bins 1 from the object shaping unit 10 onto the mounting table (e.g., 31B) without performing gas replacement in the housing 15 of the object shaping unit 10 or the like. For example, when the object shaping bin 1 is to be retrieved from the object shaping unit 10 in an argon environment, the housing 33 of the conveyance unit 30 is filled in advance with argon, and then the automatic gate valve 16 is opened to allow the conveyance means 32 to convey the object shaping bin 1 from the object shaping unit 10 to the mounting table 31B.

As a result, there is no need for the time required for the gas replacement in the housing 15 of the object shaping unit 10 or the like, and the productivity of the object shaping system can be increased.

There is a case where the heating unit 20 is filled with a gas atmosphere of argon, nitrogen, hydrogen, or the like, and the process is performed. In this case, the heating unit 20 may also be configured such that the automatic gate valve 23 of the heating unit 20 is connected to the housing 33 of the conveyance unit 30.

For example, when the object shaping bin 1 subjected to the heating process performed with the heating unit 20 inside the confining wall 21 being filled with nitrogen is retrieved therefrom, it may be appropriate to fill the housing 33 of the conveyance unit 30 with nitrogen in advance and then open the automatic gate valve 23. This allows the conveyance means 32 to convey the object shaping bin 1 from the heating unit 20 onto the mounting table (e.g., 31A).

Such a configuration eliminates the need for the time required for the gas replacement in the heating unit 20 inside the confining wall 21 and can increase the productivity of the object shaping system. Particularly when the large-sized heating unit 20 (sintering furnace) is used, this effect is remarkable. This is because, when the large-sized heating unit is used and gas replacement is performed therein, more time is required.

Also, in the second embodiment, the housing 33 of the conveyance unit 30 additionally includes an automatic gate valve 34. The automatic gate valve 34 can be used as a gate for allowing the worker to access the conveyance unit 30 in order to retrieve the object shaping bin 1 subjected to the heating process and placed on the mounting table 31A or place the empty object shaping bin 1 on the mounting table 31A for new object shaping. In the automatic gate valve 34 also, the control unit 110 of the object shaping system 100 controls an opening/closing operation based on an atmospheric situation in the housing 33. For example, when the housing 33 does not contain atmospheric air, it may be appropriate to lock the automatic gate valve 34 such that the automatic gate valve 34 is not opened for the sake of safety.

### Third Embodiment

The following will describe a third embodiment. Note that the following will describe a configuration and a process which are different from those in the embodiments described above, and a description of the same configuration and the same process as those in the embodiments described above is omitted.

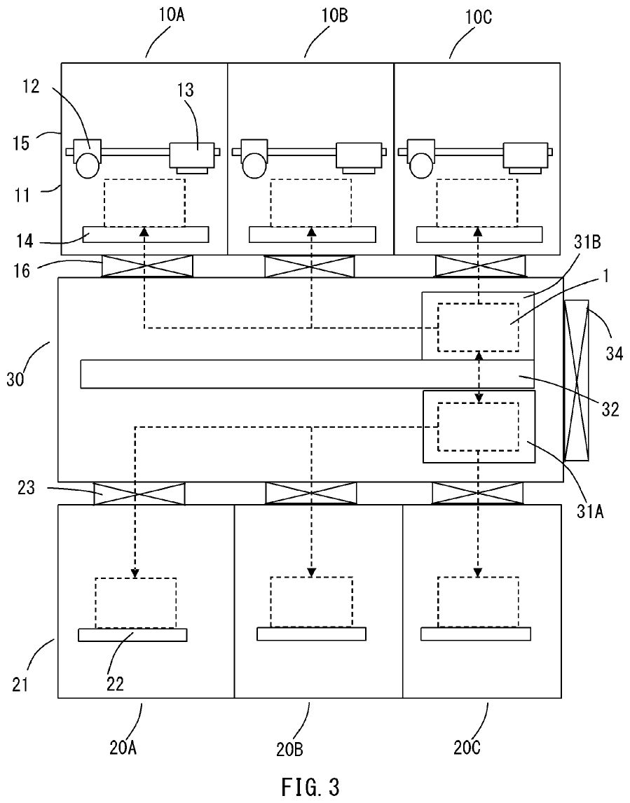

FIG. 3 is a view illustrating the object shaping system 100 of the third embodiment. FIG. 3 illustrates the object shaping system having the following configurational difference with the object shaping system in FIG. 2. Specifically, in the object shaping system of the third embodiment, a plurality of the object shaping units 10 and a plurality of the heating units 20 are provided.

FIG. 3 illustrates an example of a configuration including three object shaping units 10A, 10B, and 10C and three heating units 20A, 20B, and 20C, which is an example in which so-called clustering is performed with respect to the one conveyance unit 30.

As described above, the object shaping process and the heating process may require a period of several to several tens of hours, and process periods may also vary depending on circumstances. Accordingly, when one of the processes is ended, the ended process sequentially proceeds to the next process to allow the productivity of the object shaping system to be increased.

In the third embodiment, when the object shaping process is ended in a given one of the object shaping units 10, there are the three heating units 20 which can execute the next-step heating process.

When the three heating units 20 include the heating unit in a standby status, the heating unit may appropriately be selected and used for the heating process. When the three heating units 20 do not include the heating unit in the standby status and all the heating units are operating, the heating unit in which the process is completed first may be used appropriately.

According to the third embodiment, the probability that the object shaping process smoothly proceeds to the heating step can be increased compared to that in a mode in which there is only one heating unit. This allows the productivity of the object shaping system to be increased.

The description has been given heretofore of the mode in which one of the plurality of heating units 20 is selected and conveyance is performed, but the same applies also to the plurality of object shaping units 10. When the conveyance unit 30 is thus caused to convey one object shaping bin 1 to a destination and when the destination is operating, it may be appropriate to allow the object shaping bin 1 to stand by on the mounting table 31A or on the mounting table 31B until the operation of the destination is completed.

Alternatively, as illustrated in FIG. 3, it may also be appropriate to cause the plurality of units to operate in corporation and allow a plurality of the object shaping processes to be executed in parallel. At this time, by aiming at optimization in consideration of a starting time and an ending time for each of the units, it is possible to further increase the productivity of the entire object shaping system. The heating unit 20 may also be configured to simultaneously heat the plurality of object shaping bins 1. In that case, it may be appropriate to allow the object shaping bin 1 completely through the object shaping process to stand by in the heating unit 20 until the number of the object shaping bins 1 which have been conveyed in the heating unit 20 reaches the maximum capacity of the heating unit 20.

### Fourth Embodiment

The following will describe a fourth embodiment. Note that the following will describe a configuration and a process which are different from those in the embodiments described above, and a description of the same configuration and the same process as those in the embodiments described above is omitted.

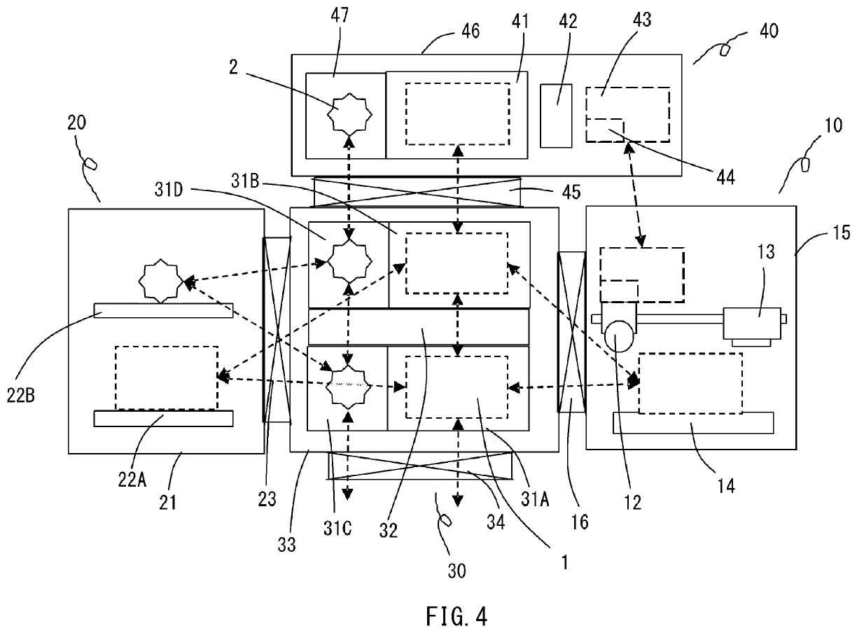

FIG. 4 is a view illustrating the object shaping system 100 of the fourth embodiment. FIG. 4 illustrates the object shaping system having the following two configurational differences with the object shaping system in FIG. 2. The first difference is that the object shaping system in FIG. 4 has a powder collecting portion (powder removing portion) 40 which removes the first powder from a non-shaping region of the layered object 4 in the object shaping bin 1 subjected to the heating process performed by the heating unit 20. The second difference is that the heating unit 20 and the conveyance unit 30 have a supporting portion 22B and mounting tables 31C and 31D on each of which a shaped object 2 extracted by removing the first powder from the non-shaping region of the layered object 4 can be placed.

First, a description will be given of the powder collecting portion.

In an object shaping method using the different sintering temperatures of the powders described above, to obtain the shaped object, the step (Step 5 described above) of removing the first powder from the non-shaping region in the object shaping bin 1 after the object shaping bin 1 is subjected to the primary heating process is required.

By returning the removed first powder to the object shaping unit and reusing the returned first powder for next object shaping, it is possible to reduce cost required for object shaping. However, the first powder has a problem that, unless the first powder is in a low humidity state, the first powder cannot be leveled when the powder layer is to be formed by the powder layer forming unit 12 of the object shaping unit 10.

A conceivable reason for this is that, when the first powder absorbs, e.g., moisture in atmospheric air or the like, the first powder clumps together. When irregular unevenness occurs when the first powder is leveled, the precision of the shaped object may be affected thereby. Accordingly, it is required to manage an amount of moisture contained in the first powder to a level which does not present a problem. If the amount of moisture is large, a step of drying the first powder is required to reuse the first powder.

Meanwhile, in the object shaping method which uses the different sintering temperatures of the powders, prior to the step of removing the first powder to extract the shaped object, the first powder is heated by the heating unit 20, while being contained the object shaping bin 1, and consequently the moisture content of the first powder is extremely low. In other words, the first powder in the non-shaping region in the object shaping bin 1 after the primary heating process is in a state appropriate for reuse in terms of humidity.

In view of this, the object shaping system in the fourth embodiment includes the powder collecting portion 40, as illustrated in FIG. 4.

The powder collecting portion 40 includes a mounting table 41 on which the object shaping bin 1 is to be placed to allow the first powder to be collected from the non-shaping region inside thereof and a collection mechanism 42. The powder collecting portion 40 also includes a containing portion 43 which contains (packs up) the first powder collected from the object shaping bin 1 by the collection mechanism 42. It may be appropriate to, e.g., provide the collection mechanism 42 with a powder pump and provide the powder pump with a function of transporting the powder to the containing portion 43 to allow the containing portion 43 to contain the powder.

The containing portion 43 includes an interface (connecting portion) 44 connectable to the powder layer forming unit 12 (powder supply unit) of the object shaping unit 10 and can move the collected first powder contained therein to the object shaping unit 10.

Thus, the object shaping system of the fourth embodiment is configured to allow the collected first powder to be easily reused by the object shaping unit 10.

It may also be possible to provide a housing 46 covering the powder collecting portion 40 and provide a humidity adjustment mechanism for holding a low humidity in the powder collecting portion 40, which is not illustrated.

Such a configuration allows the first powder in the object shaping bin 1 after the primary heating process performed by the heating unit 20 to be held in a dry state and packed up in the containing portion 43.

For example, the humidity adjustment mechanism may be configured appropriately to fill the powder collecting portion 40 with dry air, nitrogen, or the like from which moisture is removed. In this case, to hold the dry state in the powder collecting portion 40, it may also be possible to provide the housing 46 with an automatic gate valve 45 and prevent a gas flow at a high humidity from entering the housing 46.

When it is possible to allow the humidity adjustment mechanism to hold a low humidity in the powder collecting portion 40 and provide a connecting path for connecting the powder collecting portion 40, the object shaping unit 10, and the powder layer forming unit 12, the containing portion 43 need not be provided. By using the connecting path, it is possible to directly and automatically convey (transport) the powder from the powder collecting portion 40 to the powder layer forming unit 12 of the object shaping unit 10 without passage through the containing portion 43. Thus, powder transportation to the powder layer forming unit 12 may appropriately be automatically performed by the control unit 110, but it may also be possible for the worker to carry the containing portion 43 to the object shaping unit 10 and attach the containing portion 43 to the object shaping unit 10.

Also, each of the object shaping bins 1 can be conveyed by the conveyance means 32 of the conveyance unit 30 from the heating unit 20 to the mounting table 41. By thus conveying the object shaping bin 1 to the mounting table 41, it is possible to collect the first powder in an environment constantly at a low humidity and pack up the first powder in the containing portion 43.

The collection mechanism 42 may also be configured to, e.g., vacuum-collect the powder. At this time, the collection mechanism 42 may be in mode in which a vacuum nozzle is caused to automatically scan or in a mode in which the vacuum nozzle is manually operated from the outside using the housing 46 as a glove box to collect the powder.

Also, the interface 44 of the containing portion 43 may be in any mode. For example, the interface 44 may be directly connected to the powder layer forming unit 12 of the object shaping unit 10 or may alternatively be connected to a powder pump to transport the powder to the powder layer forming unit 12.

The collection mechanism 42 may appropriately include a regeneration mechanism (regeneration portion) having a function of crushing the solidified powder to regenerate the powder.

The first powder collected by the collection mechanism 42 may possibly be mixed with a solidified portion corresponding to a portion of the shaped object that has come off. Accordingly, by including the regeneration mechanism, the collection mechanism 42 can crush the solidified powder and allow the powder to be regenerated and reused.

Thus, according to the fourth embodiment, it is possible to easily reuse the first powder collected by the powder collecting portion 40. In addition, since the collection mechanism 42 includes the regeneration mechanism, even when the collected powder is mixed with the solidified powder, the powder can be regenerated. As a result, there is no need to provide an extra device for collecting and/or regenerating the first powder. Moreover, since the step of collecting the first powder and the step of regenerating the collected first powder are automated, it is possible to reduce labor and time required for these steps. This can increase the productivity of the entire object shaping system.

The description has been given heretofore of the powder collection in the object shaping method using the different sintering temperatures of the powders, but the same applies also to powder collection in an object shaping method in which a liquid binder is cured to solidify the powder in the shaping region. The powder collection may be performed appropriately in the same manner as described above in Step 15 described above.

Subsequently, a description will be given of the mounting table on which the shaped object 2 can be placed.

After being subjected to the heating process, while being contained the object shaping bin 1, and extracted by the powder collecting portion 40, the shaped object 2 is conveyed again to the heating unit 20 to be subjected to the secondary heating process to be able to have a further increased strength. When the shaped object 2 is conveyed again to the heating unit 20, the shaped object 2 may be conveyed to the heating unit 20, while being contained in the object shaping bin 1. However, the conveyance of the shaped object 2 is not limited thereto. Since the secondary heating process is performed at a temperature higher than that in the primary heating process, in consideration of thermal deformation of the object shaping bin 1 due to repeated heat cycles and damage to the object shaping bin 1 resulting from fatigue, it is preferable not to use the object shaping bin 1. As described above, the object shaping bin 1 may have a mechanism which moves the bottom plate 3 up and down in cooperation with the lifting mechanism 14. Since an amount of upward and downward movement of the bottom plate 3 may restrict a thickness of a deposited layer during the formation of the powder layer, thermal deformation of and damage to the object shaping bin 1 is not preferable.

FIG. 4 illustrates an example using, in view of the problem described above, a mode in which only the shaped object 2 is conveyed by the conveyance means 32.

The conveyance means 32 can convey the shaped object 2 from the powder collecting portion 40 to the heating unit 20 and allows the shaped object 2 through the reheating process to be placed on a mounting table 31C for the shaped object 2 provided in the conveyance unit 30.

Since the shaped object 2 has an arbitrary shape, the conveyance means 32 may also include a conveyance means for conveying the object shaping bin 1 having a determined shape and another conveyance means for conveying the shaped object 2 having an arbitrary shape. For example, the conveyance means 32 may also be in a mode in which a multi-limb/multi-junction robot hand holds the shaped object 2 or the object shaping bin 1 in a different configuration corresponding to each shape. It may also be possible that the conveyance means 32 includes an extra camera, senses a position and a posture of the shaped object 2, and performs control to allow the robot hand to hold an appropriate portion of the shaped object 2.

It may also be possible to provide respective mounting tables for the shaped object 2 in the powder collecting portion 40 and the conveyance unit 30. For example, a mounting table 47 provided in the powder collecting portion 40 may also be used as a mounting table on which the extracted shaped object 2 is to be placed. Alternatively, the other mounting table 31D provided in the conveyance unit 30 may also be used as a standby place until the heating unit 20 becomes empty. It is not necessarily required to temporarily place the shaped object 2 on the mounting table 31C. When the heating unit 20 can perform the secondary heating process with no standby time, such as when the heating unit 20 can simultaneously perform a heating process on a large number of the shaped objects 2, it is possible to provide the conveyance means 32 with a holding mechanism and use a mechanism which allows the holding mechanism to hold the shaped object 2 contained in the powder collecting portion 40 and directly move the shaped object 2 to the heating unit 20. Meanwhile, the empty object shaping bin 1 from which the first powder located in the internal non-shaping region and the shaped object have been removed by the powder collecting portion 40 is retrieved from the powder collecting portion 40 by the conveyance means 32 and conveyed. The object shaping bin 1 may appropriately be reusable. When the object shaping bin 1 is reusable, the conveyance means 32 may be configured appropriately to carry the empty object shaping bin 1 into the object shaping unit 10. It may be appropriate that, in the object shaping unit 10, a powder layer is formed again in the empty object shaping bin 1 thus carried in. At this time, when the object shaping unit 10 is operating, the object shaping bin 1 is allowed to be placed on any of the mounting tables 31A, 31B, and 41 on which the object shaping bin 1 can be placed and stand by until the object shaping bin 1 is carried into the object shaping unit 10. In the heating unit 20, the supporting portion 22B other than the supporting portion 22A on which the object shaping bin 1 is to be placed may also be provided to allow the shaped object 2 to be placed thereon.

By thus separately providing the mounting table (supporting portion) on which the object shaping bin 1 is to be placed and the mounting table (supporting portion) on which the shaped object 2 is to be placed, the process of conveying the object shaping bin 1 and the process of conveying the shaped object 2 can be performed independently of each other. This prevents a situation in which the object shaping bin 1 and the shaped object 2 respectively obstruct the conveyance of the shaped object 2 and the conveyance of the object shaping bin 1 to impede the conveyance processes. Accordingly, it is possible to increase the productivity of the entire object shaping system.

Note that, when the shaped object 2 is to be conveyed and placed, it is required to determine a grip force applied from a holding portion to the shaped object 2, an acceleration rate at which the shaped object 2 is moved, and a rigidity and a hardness of the holding portion so as to prevent the conveyance means 32 from entirely or partially damaging the shaped object 2. Likewise, when the conveyance means 32 places the shaped object 2 on the mounting table 31C, 31D, or 47, it is concerned that a certain amount of drop impact is applied to the shaped object 2. Accordingly, it is desirable to provide the mounting tables 31C, 31D, and 47 each having a low rigidity and a low hardness. For example, the rigidity of each of the mounting tables 31C, 31D, and 47 of the shaped object 2 is preferably lower than that of each of the mounting tables 31A, 31B, and 41 for the object shaping bin 1, and more preferably lower than the rigidity and hardness of the shaped object 2. Specifically, a material having a low rigidity and a low hardness, such as resin, sponge, or fabric, may be used or, alternatively, a table having a reduced rigidity as a result of being formed into a certain shape, such as a net shape, may also be used.

In the mode illustrated in the fourth embodiment, the shaped object 2 is directly held and conveyed by the conveyance means 32. However, the mode to be used in the fourth embodiment is not limited thereto, and a mode in which another containing portion for the secondary heating process is provided may also be used. The other containing portion is not intended to be used to form the powder layer and need not cooperate with the lifting mechanism of the object shaping unit 10 or the like. Accordingly, thermal deformation of the other containing portion does not affect the shaped object 2. The other containing portion may appropriately have a size which allows the shaped object 2 to be included in the other containing portion.

Alternatively, it may also be possible to perform the secondary heating process using the object shaping bin 1. In this case, an object to be conveyed by the conveyance means 32 is only the object shaping bin 1, which is advantageous in that only one holding portion is sufficient to be provided in the conveyance means 32. Note that, in this case, it is desirable that the object shaping bin 1 may be replaceable when the object shaping bin 1 is thermally deformed or damaged. Also, in the fourth embodiment, the heating unit 20 which performs the primary heating process also serves as the heating unit which performs the secondary heating process, but the heating unit to be used in the fourth embodiment is not limited thereto. It may also be possible that a heating unit which performs the secondary heating process is provided separately from the heating unit 20.

As described heretofore, according to the fourth embodiment, the control unit 110 can automatically perform a sequence of object shaping steps in the object shaping system. This can reduce labor and working hours required of the worker and increase the productivity of the entire object shaping system.

Note that the procedures of the control and the operation or the like illustrated in each of the embodiments described above are not limited thereto. Also, the configurations, the layouts, the number of each of the components, and the like illustrated in FIGS. 1A and 2 to 4 are not limited thereto. Also, a method of supplying the powder in the object shaping unit 10 is not particularly limited thereto. For example, a configuration in which an extra powder supply mechanism is provided in the lifting mechanism 14 may also be used. The configuration is appropriate as long as an interface connectable to the containing portion 43 containing the collected powder is provided to allow the powder in the containing portion to be reused in the object shaping unit.

The configuration of the conveyance means 32 is also not limited to the robot hand, and another means other than the robot hand may also be used. Also, a plurality of the conveyance units may also be provided or a plurality of types of conveyance means may also be provided.

The conveyance of the object shaping bin 1 or the shaped object 2 by the conveyance means 32 need not necessarily be performed via a mounting table. For example, the object shaping bin 1 or the shaped object 2 may be conveyed directly from the object shaping unit 10 to the heating unit 20 and need not necessarily be temporarily placed on the mounting table 31 of the conveyance unit 30. In such a mode, the conveyance unit 30 need not necessarily include a mounting table.

Each of the object shaping unit 10, the heating unit 20, the conveyance unit 30, and the powder collecting portion 40 may also be configured to include an extra hatch for maintenance (such as an openable/closable opening) to allow the worker to access the inside of each of the object shaping unit 10, the heating unit 20, the conveyance unit 30, and the powder collecting portion 40. The object shaping bin 1 may also be manually conveyed by the worker from the mounting table 31 to the outside of the object shaping system and from the outside of the object shaping system to the mounting table 31. Alternatively, the object shaping bin 1 may also be conveyed to an external system or to an external table using the conveyance means 32.

### OTHER EMBODIMENTS

The present invention can also be implemented by executing the following processing: that is, software (programs) which implement the functions of the above-mentioned embodiment is supplied to a system or an apparatus via a network or various storage media, and the computer (or CPU or MPU) of the system or the apparatus reads and executes the program codes. In this case, the programs and the storage media storing the programs constitute the present invention. The present invention can also be implemented by a circuit (e.g. ASIC) which implements at least one function.

According to the present invention, labor and working hours required of workers can be reduced to improve productivity.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-216550, filed on Nov. 19, 2018, which is hereby incorporated by reference herein in its entirety.

What is claimed is:

1. An object shaping system comprising:
an object shaping portion including a powder layer forming unit which forms a powder layer in a vessel using a first powder and a liquid supplying unit which supplies, to a local region of the powder layer, a liquid for solidifying the first powder based on three-dimensional shape data of a solid model, the object shaping portion repeatedly performing a sequential object shaping operation including an operation of forming the powder layer which is performed by the powder layer forming unit and an operation of supplying the liquid which is performed by the liquid supplying unit to form a layered object in the vessel;
a first heating portion which performs a heating operation of heating the vessel in which the layered object is formed by the object shaping portion;
a conveyance mechanism capable of conveying the vessel; and
a control unit which controls the object shaping portion, the first heating portion, and the conveyance mechanism, wherein
each of the object shaping portion, the first heating portion, and the conveyance mechanism is an independent unit, and,
when the object shaping operation performed by the object shaping portion is completed, the control unit disconnects, from the object shaping portion, the vessel in which the layered object is formed and causes the conveyance mechanism to convey the vessel from the object shaping portion to the heating portion.

2. The object shaping system according to claim 1, wherein
the object shaping portion and the conveyance mechanism are individually covered with respective housings connected to each other via a gate valve, and each of the housings has a gas supply mechanism.

3. The object shaping system according to claim 1, further comprising:
a powder removing portion for removing, from the layered object in the vessel heated by the first heating portion, the first powder located outside the local region, wherein,
when the heating operation performed by the first heating portion is completed, the control unit causes the conveyance mechanism to disconnect the heated vessel from the first heating portion and convey the vessel to the powder removing portion.

4. The object shaping system according to claim 3, further comprising:
a second heating portion for heating, after the first powder located outside the local region is removed from the layered object in the vessel, the powder located in the local region so as to sinter particles included in the first powder to each other, wherein,
when the removal of the first powder located outside the local region by the powder removing portion is completed, the control unit causes the conveyance mechanism to convey, from the powder removing portion to the second heating portion, a shaped object obtained through the removal of the first powder located outside the local region from the layered object.

5. The object shaping system according to claim 4, wherein
the conveyance mechanism includes a holding mechanism, and
the control unit causes the holding mechanism to hold the shaped object and convey the shaped object from the powder removing portion to the second heating portion.

6. The object shaping system according to claim 4, wherein
the control unit causes the shaped object after the removal of the first powder located outside the local region to be conveyed from the powder removing portion to the second heating portion, while being contained in the vessel.

7. The object shaping system according to claim 4, wherein
the first heating portion serves also as the second heating portion.

8. The object shaping system according to claim 1, further comprising:
a vibration damping means for reducing vibration transmitted from the conveyance mechanism to the vessel.

9. The object shaping system according to claim 1, wherein
the liquid is mixed with a second powder having an average particle diameter smaller than that of the first powder.

10. The object shaping system according to claim 5, wherein
the conveyance mechanism is capable of retrieving, from the powder removing portion, the empty vessel from which the powder and the shaped object have been removed and conveying the empty vessel.

11. The object shaping system according to claim 3, wherein
the powder removing portion has a regeneration portion which collects the powder located outside the local region and removed from the layered object and regenerates the collected powder such that the regenerated powder is usable as a powder for forming the powder layer.

12. The object shaping system according to claim 1, wherein
the conveyance mechanism includes a mounting portion on which one or more vessels, each being the vessel, are allowed to be placed.

13. The object shaping system according to claim 12, wherein
the conveyance mechanism is capable of conveying the vessel placed on the mounting portion to the object shaping portion.

14. The object shaping system according to claim 12, wherein,
when the control unit causes the conveyance mechanism to convey the vessel to a destination and the destination is operating, the control unit causes the vessel to stand by on the mounting portion until the operation of the destination is completed.

15. The object shaping system according to claim 12, wherein
a plurality of object shaping portions, each being the object shaping portion, are provided, and,
when the vessel is placed on the mounting portion, the control unit selects any one of the plurality of object shaping portions and causes the conveyance mechanism to convey the vessel to the selected object shaping portion and place the vessel in the selected object shaping portion.

16. The object shaping system according to claim 15, wherein,
when selecting the object shaping portion, the control unit selects, from among the plurality of object shaping portions, an object shaping portion which allows earliest start of the object shaping operation on the vessel.
